(19) United States
(12) Patent Application Publication
(10) Pub. No.: US 2003/0117935 A1
(43) Pub. Date: Jun. 26, 2003

(54) Rotary drive device

(76) Inventors: Shinichi Utsumi, Nagano (JP); Atsushi Honda, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/308,853

(22) Filed: Dec. 3, 2002

(30) Foreign Application Priority Data
Dec. 6, 2001 (JP) 2001-373122

(51) Int. Cl. G11B 23/00; G11B 25/00

(52) U.S. Cl. 369/263; 369/264

(57) ABSTRACT

A rotary drive device includes a plurality of balancing balls that are held to a holding magnet during low speed rotation, including when a rotary body starts. The balancing balls move outward in the radial direction away from the holding magnet by a centrifugal force applied to the plurality of balancing balls as a result of the rotation of the rotary body. Each of the balancing balls is moved into a position that negates a rotational unbalance of the rotary body to achieve a balancing effect. The number of effective revolutions, at which point the plurality of balancing balls that is attracted to the holding magnet begins to move outward in the radial direction away from the holding magnet as the number of revolutions of the rotary body increases, is smaller than the number of resonant revolutions of the rotary body.

### BACKGROUND OF THE INVENTION

1. Field of the Invention

The present invention relates to rotary drive devices with a self-balancing mechanism that negates rotational unbalance of rotating bodies.

2. Related Background Art

In general, various types of rotary drive devices used in industrial machinery, home appliances and computers often make use of self-balancing devices to negate rotational unbalance of a rotary body that includes a rotary shaft. Various structures for self-balancing devices have been proposed. As shown in FIG. 6, one of such self-balancing devices includes a self-balancing mechanism A that includes a hollow circular ring-shaped case 3 attached to a rotary shaft 2, which is an output shaft of a motor section 1, and a plurality of balancing spherical bodies (i.e., balls) 4 housed in a freely movable manner inside the hollow circular ring-shaped case 3.

During low speed rotation including when the motor section 1 starts, each of the balancing spherical bodies 4 is held attracted to an outer circumference surface of a holding magnet 5, which is positioned at the center part in the radial direction of the hollow circular ring-shaped case 3. When the number of revolutions of the motor section 1 exceeds the number of resonant revolutions CR, each of the balancing spherical bodies 4 begins to move outward in the radial direction away from the holding magnet 5. By having each of the balancing spherical bodies 4 move in a direction opposite the position of center of gravity of the rotary body, including the rotary shaft 2 and the self-balancing mechanism A, i.e., to move into a position that negates a rotational unbalance of the rotary body, a balancing effect that balances the rotation of the rotary body takes place, and the balancing effect achieved by each of the balancing spherical bodies 4 reduces the vibration of the rotary body and stabilizes the rotating condition of the rotary body.

In this way, each of the balancing spherical bodies 4 is configured to be securely held on the holding magnet 5 side in conventional self-balancing devices until the number of revolutions of the motor section 1 exceeds the number of resonant revolutions CR. As a result, a magnet with relatively strong magnetic force is used as the holding magnet 5.

However, when the magnetic force of the holding magnet 5 is strong, although the holding property of the balancing spherical bodies 4 during low speed rotation is favorable as shown in FIGS. 7 (a) and 7 (b), the plurality of balancing spherical bodies 4 is influenced by the strong magnetic force of the holding magnet 5 when the balancing spherical bodies 4 move freely to achieve a balancing effect, so that the balancing spherical bodies 4 repel each other, as shown especially in FIGS. 7 (c) and 7 (d). As a result, the plurality of balancing spherical bodies 4 becomes unable to concentrate in a position they should move to in order to resolve an unbalance and instead becomes scattered, which sometimes makes it impossible to fully produce the balancing effect.

In the opposite situation, where the holding magnet 5 is removed as shown in FIGS. 8 (a) and 8 (b), although the balancing effect can be favorably obtained, the balancing spherical bodies 4 collide with each other forcefully and frequently during low speed rotation; the sound of the balancing spherical bodies 4 colliding with each other becomes a loud noise when the device is operated, which is unpleasant to users. Such a noise problem is especially prominent in vertically oriented devices, in which a rotary shaft is horizontal, as shown in FIGS. 7 and 8.

### SUMMARY OF THE INVENTION

In view of the above, the present invention relates to a self-balancing device for motors, in which a favorable balancing effect can be obtained through balancing spherical bodies and noise from the balancing spherical bodies colliding with each other is reduced.

In accordance with an embodiment of the present invention, a rotary drive device includes a plurality of balancing spherical bodies that are held to a holding magnet during low speed rotation, including when a rotary body starts, which move outward in the radial direction away from the holding magnet by a centrifugal force applied to the plurality of balancing spherical bodies as a result of the rotation of the rotary body, wherein each of the balancing spherical bodies is moved into a position that negates a rotational unbalance of the rotary body to achieve a balancing effect. In one aspect, the number of effective revolutions, at which point the plurality of balancing spherical bodies that is attracted to the holding magnet begins to move outward in the radial direction away from the holding magnet as the number of revolutions of the rotary body increases, is smaller than the number of resonant revolutions of the rotary body.

In a rotary drive device having such a configuration, due to the fact that the magnetic force that acts on each of the plurality of the balancing spherical bodies is set low enough that the balancing spherical bodies begin to move outward in the radial direction away from the holding magnet before the number of revolutions of the rotary body reaches its number of resonant revolutions, the repulsive force among the balancing spherical bodies is weakened, and the plurality of balancing spherical bodies can be positioned to concentrate in an area that can resolve an unbalance of the rotary body, which yields sufficient balancing effect.

Even if the plurality of balancing spherical bodies moves freely during low speed rotation of the rotary body, the balancing spherical bodies repel each other due to the magnetic effect of the holding magnet, which causes collisions among the balancing spherical bodies to be weak and infrequent, which in turn mitigates noise.

Further in the rotary drive device according to the present invention, the magnetic force that acts on the balancing spherical bodies may be set at a force that allows the balancing spherical bodies to move outward in the radial direction away from the holding magnet before the number of revolutions of the rotary body reaches its number of resonant revolutions. As a result, the number of effective revolutions can be achieved directly and securely.

In the meantime, in one embodiment, the number of effective revolutions may be set at 1900 rpm or less when the number of resonant revolutions of the rotary body is 2000 rpm to 3000 rpm. More preferably, the number of effective revolutions may be set within the range between 1000 rpm and 1400 rpm when the number of resonant revolutions of the rotary body is 2000 rpm to 3000 rpm, the effects described above can be securely obtained.

In accordance with another embodiment of the present invention, a rotary drive device comprises a chucking magnet, which fixes a disk member mounted on a rotary body, and a self-balancing mechanism, which uses a balancing effect to negate any rotational unbalance of the rotary body that occurs when the number of revolutions of the motor section that drives the rotary body exceeds the number of resonant revolutions of the rotary body, wherein the chucking magnet is formed from a multipolar magnet with four or more magnetic poles in the circumferential direction.

In the rotary drive device having such a configuration, due to the fact that leakage flux from the chucking magnet to the holding magnet is more uniform and smaller in the circumferential direction, the impact of the leakage flux of the chucking magnet on the holding magnet is reduced. In other words, the magnetic attractive effect of the holding magnet on the balancing spherical bodies becomes uniform in the circumferential direction, which reduces the impact on the balancing spherical bodies, so that a noise reduction effect of the holding magnet on the balancing spherical bodies is enhanced, while the balancing spherical bodies achieve the balancing effect more effectively.

Furthermore, in accordance with another embodiment of the present invention, a rotary drive device comprises a chucking magnet, which fixes a disk member mounted on a rotary body, and a self-balancing mechanism, which uses a balancing effect to negate any rotational unbalance of the rotary body that occurs when the number of revolutions of a motor section that drives the rotary body exceeds the number of resonant revolutions of the rotary body, wherein the chucking magnet is formed from a single-pole magnet with a uniform magnetic pole in the circumferential direction.

In the rotary drive device having such a configuration, due to the fact that leakage flux from the chucking magnet to a holding magnet is made completely uniform in the circumferential direction, the impact of the leakage flux unbalance of the chucking magnet is eliminated and the magnetic attractive force of the holding magnet on a plurality of balancing spherical bodies is made uniform in the circumferential direction. As a result, a noise reduction effect of the holding magnet on the balancing spherical bodies is further enhanced without any impact on the balancing effect achieved by the balancing spherical bodies, while the balancing spherical bodies in fact achieve the balancing effect even more effectively.

In accordance with another embodiment of the present invention, a rotary drive device comprises a plurality of balancing spherical bodies that are attracted to the holding magnet during low speed rotation, including when a rotary body starts, move outward in the radial direction away from the holding magnet by a centrifugal force applied to the plurality of balancing spherical bodies as a result of the rotation of the rotary body, wherein each of the balancing spherical bodies is moved into a position that negates a rotational unbalance of the rotary body to achieve a balancing effect. In one aspect, the balancing spherical bodies are made of a material with little residual magnetism. As a result, the magnetic effect of the holding magnet on the balancing spherical bodies acts consistently at all times regardless of the orientation or posture of the balancing spherical bodies. Consequently, the repulsive force among the plurality of balancing spherical bodies also acts consistently at all times, which effectively prevents noise caused by collisions among the balancing spherical bodies and causes the balancing effect to be achieved even more effectively.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1 is an exterior perspective view of a CD-ROM or DVD drive unit as an example of a device to which the present invention is applied.

FIG. 2 is a longitudinal cross section indicating one embodiment of a motor with a self-balancing device used in the CD-ROM or DVD drive unit shown in FIG. 1.

FIG. 3 is an exterior perspective view of one example of a chucking magnet with a four pole-magnetized structure used in the motor with the self-balancing device shown in FIG. 2.

FIG. 4 is a line graph indicating the relationship between the magnetic force of a holding magnet and vibration/noise of a rotary body.

FIG. 5 is a line graph indicating the relationship between magnetic flux and circumferential angle of a chucking magnet.

FIG. 6 is a longitudinal cross section of an example of structure of a rotary drive device with a general self-balancing mechanism.

FIGS. 7 (a)-7 (d) are side views indicating internal states of self-balancing mechanisms when rotary drive devices are vertically oriented.

FIGS. 8 (a)-8 (b) are side views indicating internal states of self-balancing mechanisms when rotary drive devices without holding magnets are vertically oriented.

### DESCRIPTION OF PREFERRED EMBODIMENTS

Next, an embodiment of the present invention is described in detail with reference to the accompanying drawings.

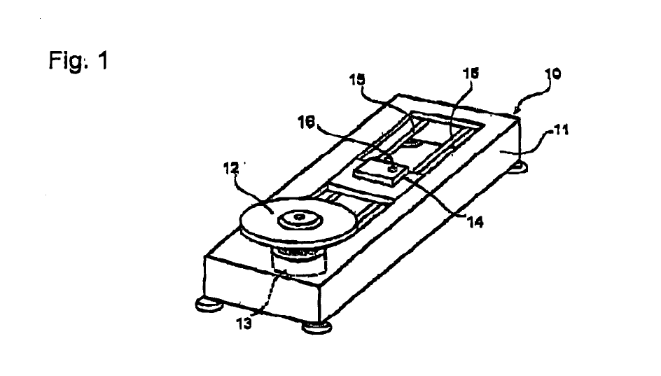

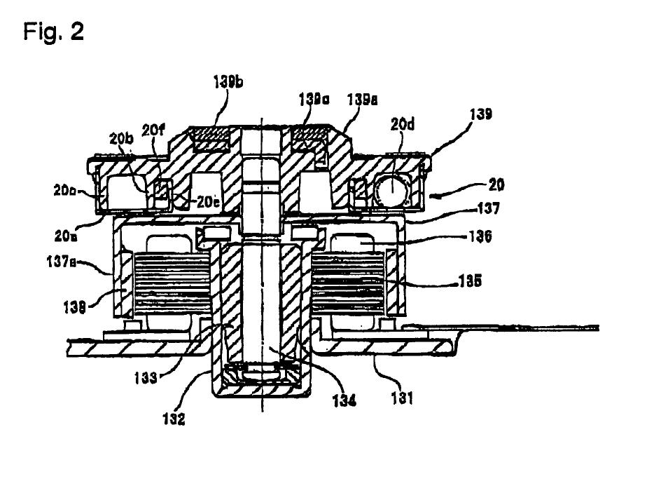

First, the overall structure of a CD-ROM or DVD drive unit to which the present invention is applied is described. On a mechanical chassis 11 of a CD-ROM drive unit 10 shown in FIG. 1, a spindle motor section 13, which rotatably drives a recording disk 12, and an optical pickup device 14, which writes or reads information to and from the recording disk 12 by irradiating a laser beam on it, are mounted. The recording disk 12 is mounted on a disk table (marked 139 in FIG. 2), which is attached to a rotary shaft of the spindle motor section 13.

The optical pickup device 14 is mounted reciprocativelly on a pair of parallel guide shafts 15, 15 that are attached to the mechanical chassis 11, and the optical pickup device 14 irradiates a luminous flux generated from a laser beam source, omitted from drawings, through an objective lens 16 at the recording disk 12 and detects reflective light from the recording disk 12.

In the meantime, in the spindle motor section 13 as shown especially in FIG. 2, a bearing holder 132, which is in a hollow cylindrical shape, is attached to a main body frame 131 in an upright manner generally vertical, and a bearing member 133 is mounted through press fitting inside the hollow interior of the bearing holder 132. The bearing member 133 has bearing sections at two places in the axial direction, and the bearing member 133 may be any of various bearing members such as an oil-impregnated sliding bearing, a rolling bearing, a metal bearing or a dynamic pressure bearing device.

At the center part of the bearing holder 132, a rotary shaft 134 is rotatably supported via the bearing member 133, and a stator core 135, which consists of a laminate of silicon steel plates, is mounted on an outer circumference wall surface of the bearing holder 132. On the surface of the stator core 135, an insulating layer is coated by an appropriate method such as paining, and a coil 136 is wound via the insulating layer around an area that corresponds to each salient pole of the stator core 135.

Immediately above the bearing holder 132 in FIG. 2, the center part of a generally cup-shaped rotor case 137, which is formed in a hollow cylindrical shape, is fixed to the rotary shaft 134, and a rotary magnet 138, which is formed in a ring shape, is fixed on an inner circumference surface of a circular ring-shaped wall section 137a that is provided on the outer circumference part of the rotor case 137. The inner circumference surface side of the rotor magnet 138 is positioned on the outer side in the radial direction in close proximity to each salient pole of the stator core 135.

At a protruding section at the top of the rotary shaft 134, a disk table (turntable) 139 formed with a generally disk-shaped resin material (polycarbonate) is fixed. The disk table 139 is fixed by press-fitting its rotary shaft press fitting hole, which is formed at the center section, with the rotary shaft 134; a generally truncated cone-shaped positioning protrusion 139a that is formed concavely to encompass the fixing part holds in its place a recording disk (marked 12 in FIG. 1 but omitted from FIG. 2) that is mounted on the disk table 139. At the apex section of the positioning protrusion 139a, a ring-shaped chucking magnet 139b is attached via a yoke 139c.

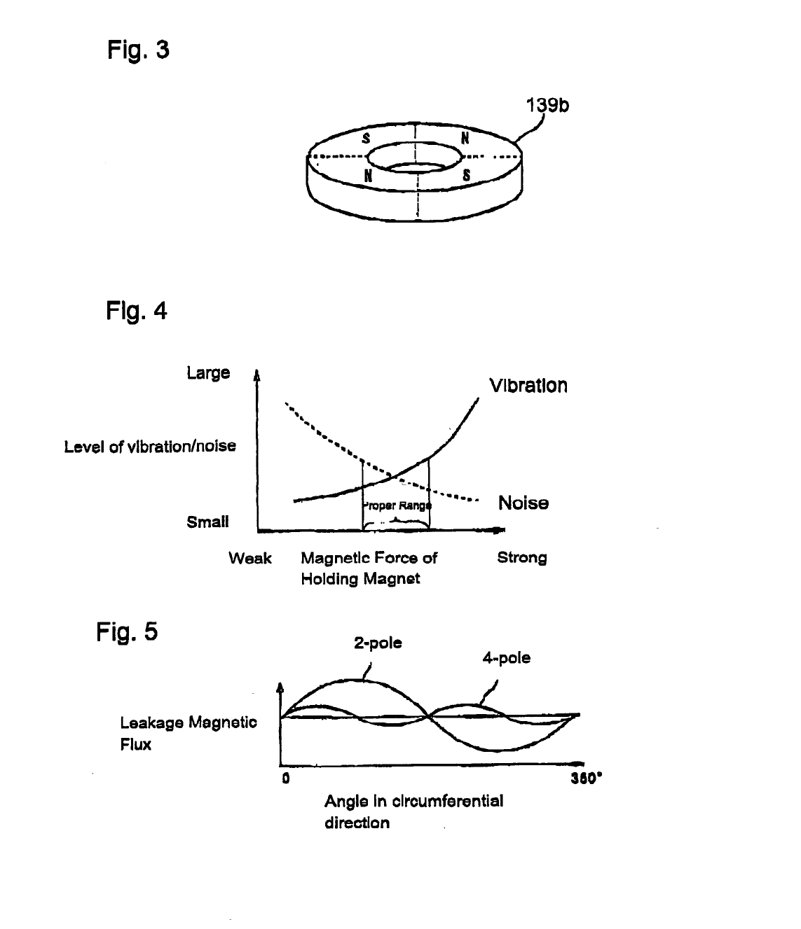

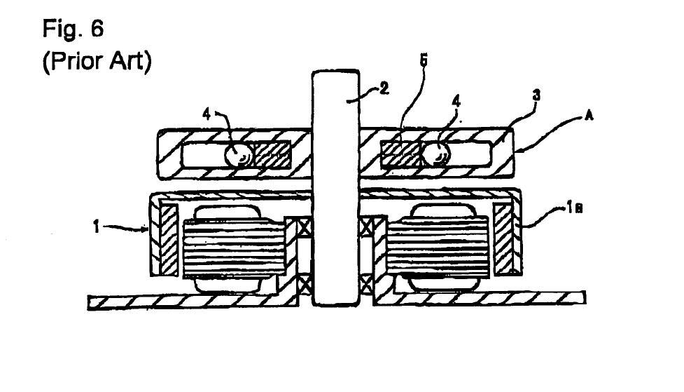

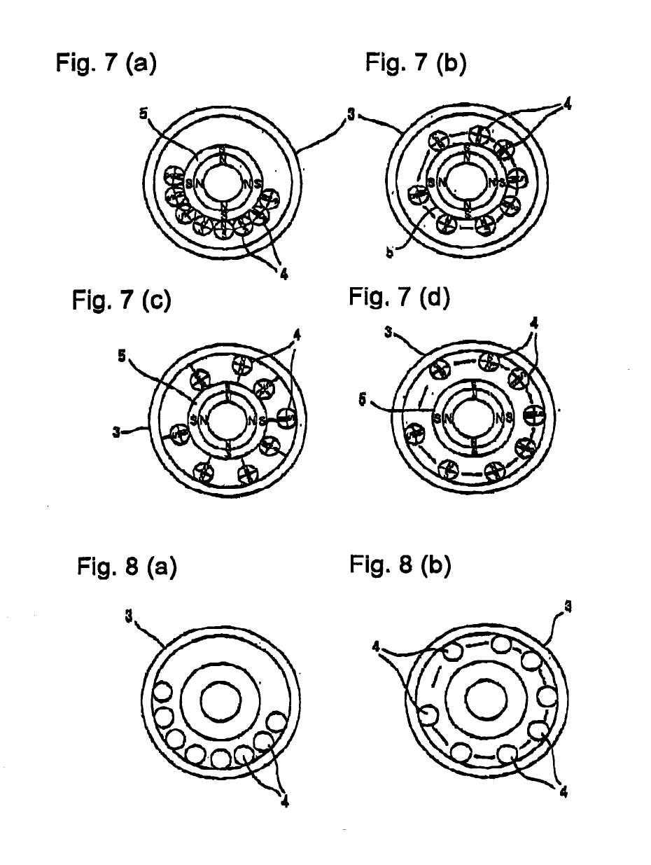

The chucking magnet 139b is positioned to be exposed on the outside of the center hole of the recording disk 12 that is mounted on the positioning protrusion 139a of the disk table 139, and is provided to attract and hold a magnetic pressing ring that is provided on the side of a pressing member (omitted from drawings) for the recording disk 12. Either a multipolar magnet with four or more magnetic poles in the circumferential direction or a single-pole magnet with a uniform magnetic pole in the circumferential direction is used as the chucking magnet 139b. When four or more magnetic poles are formed in the circumferential direction, magnetic poles can be formed so that there are four magnetic poles in the circumferential direction, as shown in FIG. 3, for example. When forming a uniform magnetic pole in a single-pole magnet, the same magnetic pole can be formed in the circumferential direction, or, as shown in FIG. 7, the same magnetic poles in the circumferential direction can be formed in the radial direction. The chucking magnet 139b is magnetized in the axial direction so that it can attract and hold the magnetic pressing ring.

Referring back to FIG. 2, immediately below in the axial direction of the disk table 139 is provided a self-balancing mechanism 20 that balances the rotation of a rotary body, including the rotor case 137 and the rotary shaft 134. The self-balancing mechanism 20 has a function to negate, through a balancing effect resulting from mass transfer, any rotational unbalance that occurs in the rotary body when the number of revolutions of the motor section 13 exceeds the number of resonant revolutions CR of the rotary body. On the bottom side of the disk table 139, a hollow circular ring-shaped case 20a, which comprises a part of a housing to house balancing spherical bodies 20d to be described later, is mounted to rotate in a unitary fashion with the disk table 139.

The hollow circular ring-shaped case 20a is made of a nonmagnetic material that forms a circular ring-shaped groove section that is generally U-shaped in a transverse cross section; and on the inner side of the circular ring-shaped groove section formed by the hollow circular ring-shaped case 20a are an inner circumference wall 20b and an outer circumference wall 20c, which protrude in concentric ring shapes from the disk table 139 positioned at the top half and are mounted to comprise parts of the housing. The inner circumference wall 20b and the outer circumference wall 20c are formed with a resin material (polycarbonate), which is in a unitary structure with the disk table 139, and are positioned to extend in the axial direction (in the vertical direction in the figure) with an appropriate distance in the radial direction provided between them. The space formed between the inner circumference wall 20b and the outer circumference wall 20c forms the hollow circular ring-shaped housing, and the plurality of balancing spherical bodies 20d, 20d . . . consisting of magnetic masses is housed inside the housing space in a freely movable manner in the circumferential and radial directions. Each of the balancing spherical bodies 20d is formed with a material with minimal residual magnetism (i.e., substantially reduced residual magnetism than that of an ordinary magnetic material), such as chrome steel (SUJ-2), and is freely movable in the radial and circumferential directions along a bottom wall surface of the hollow circular ring-shaped case 20a.

Each of the balancing spherical bodies 20d is configured to perform a balancing effect for the rotary body, including the rotor case 137 and the rotary shaft 134. In other words, when the number of revolutions of the spindle motor section 13 is at an appropriate number of revolutions exceeding the number of resonant revolutions CR of the rotary body, mass adjustment takes place by the movement of the balancing spherical bodies 20d in a direction opposite the position of center of gravity of the rotary body, i.e., outward in the radial direction indicated by a double-dot and dash line in FIG. 2 that negates the rotational unbalance of the rotary body; this balances the rotation of the rotary body, thereby reducing the vibration and stabilizing the rotation of the rotary body.

A center-side inner wall 20e of the hollow circular ring-shaped case 20a is positioned more interior toward the center than even the inner circumference wall 20b that extends from the disk table 139. Between the center-side inner wall 20e of the hollow circular ring-shaped case 20a and the inner circumference wall 20b is formed an appropriate space, and a ring-shaped holding magnet 20f, which attracts the balancing spherical bodies 20d, is mounted in the space. The holding magnet 20f is magnetized in a single pole in the radial direction and configured to magnetically attract each of the balancing spherical bodies 20d, 20d . . . during low speed rotation until the number of revolutions of the spindle motor section 13 reaches an appropriate number of effective revolutions before exceeding the number of resonant revolutions CR, so that each of the balancing spherical bodies 20d, 20d . . . is held in a fixed state pulled towards, and in contact with, the inner circumference wall 20b.

In the present embodiment, the number of effective revolutions at which point each of the balancing spherical bodies 20d, 20d . . . moves away from the holding magnet 20f is set as a number of revolutions LR that is smaller than the number of resonant revolutions CR of the rotary body. In other words, the number of effective revolutions LR is the number of revolutions at which point each of the balancing spherical bodies 20d, 20d . . . that was attracted to and held by the holding magnet 20f begins to move outward in the radial direction away from the holding magnet 20f as the number of revolutions of the rotary body increases. More specifically, when the number of resonant revolutions of the rotary body is about 2000 rpm to about 3000 rpm, elements involved in the movement of the balancing spherical bodies 20d are set appropriately so that the number of effective revolutions LR would be about 1900 rpm or less. The elements involved in the movement of the balancing spherical bodies 20d include direct setting of the magnetic force of the holding magnet 20f, the outer diameter of the holding magnet 20f, the size, mass and material of the balancing spherical bodies 20d, the initial radial distance between the holding magnet 20f and the balancing spherical bodies 20d, and the coefficient of friction of each surface that the balancing spherical bodies 20d come into contact with.

When the number of resonant revolutions CR of the rotary body is about 2000 rpm to about 3000 rpm, the number of effective revolutions LR may preferably be set within a range of about 1000 rpm to about 1400 rpm in consideration of countermeasures for noise and repulsive force among the balancing spherical bodies 20d.

In a rotary drive device equipped with the self-balancing mechanism 20 according to the present embodiment having such a configuration, due to the fact that the magnetic force that acts on each of the plurality of balancing spherical bodies 20d is small enough that the balancing spherical bodies 20d begin to move outward in the radial direction away from the holding magnet 20f before the number of revolutions of the rotary body reaches the number of resonant revolutions CR, the repulsive force among the balancing spherical bodies 20d is weakened and the plurality of balancing spherical bodies 20d can be positioned to concentrate in an area that can resolve the unbalance of the rotary body. This yields sufficient balancing effect to effectively reduce the vibration level of the rotary body.

Even if the plurality of balancing spherical bodies 20d moves freely during low speed rotation of the rotary body, the balancing spherical bodies 20d repel each other due to the magnetic effect of the holding magnet 20f, which causes collisions among the balancing spherical bodies 20d to be weak and infrequent, which in turn effectively reduces the noise level of the rotary body.

In the rotary drive device with the self-balancing mechanism 20 according to the present embodiment, due to the fact that the number of effective revolutions LR is set as the number of revolutions at which point the balancing spherical bodies 20d that were attracted to and held by the holding magnet 20f begin to move outward in the radial direction away from the holding magnet 20f as the number of revolutions of the rotary body increases, by adjusting and setting the coercive force of the holding magnet 20f (x-axis in FIG. 4) within a proper range, both the vibration level and noise level of the rotary body (y-axis in FIG. 4) become reduced, as shown in FIG. 4. For example, when the outer diameter of the holding magnet 20f is 17 mm and each balancing spherical body 20d consists of a 3 mm-diameter chrome steel, both the vibration level and noise level of the rotary body can be reduced by adjusting and setting the coercive force bHc of the holding magnet 20f at approximately 950 kA/m.

Further in the rotary drive device with the self-balancing mechanism 20 according to the present embodiment, due to the fact that the number of effective revolutions LR is set at 1900 rpm or less, and preferably within the range of 1000 rpm to 1400 rpm, when the number of resonant revolutions CR of the rotary body is 2000 rpm to 3000 rpm, the effects described above can be securely obtained.

In the rotary drive device with the self-balancing mechanism 20 according to the present embodiment, due to the fact that the chucking magnet 189 consists of a multipolar magnet with four or more magnetic poles in the circumferential direction, the amount of leakage flux (y-axis in FIG. 5) from the chucking magnet 139b to the holding magnet 20f is more uniform and smaller in the circumferential direction (x-axis in FIG. 5) compared to normal bipolar magnets, as shown in FIG. 5. This reduces the influence of the leakage flux of the chucking magnet 139b on the holding magnet 20f, so that a noise reduction effect of the holding magnet 20f on the balancing spherical bodies 20d is enhanced without any impact on the balancing effect achieved by the balancing spherical bodies 20d, while the balancing spherical bodies 20d in fact achieve the balancing effect more effectively.

Furthermore, when the chucking magnet 139b according to the present embodiment consists of a single-pole magnet with a single magnetic pole in the circumferential direction, due to the fact that the leakage flux from the chucking magnet 139b to the holding magnet 20f is uniform in the circumferential direction, the impact from the leakage flux of the chucking magnet 139b on the holding magnet 20f is eliminated and the magnetic attractive force of the holding magnet 20f on the balancing spherical bodies 20d becomes uniform in the circumferential direction. As a result, the noise reduction effect of the holding magnet 20f on the balancing spherical bodies 20d is further enhanced without any impact on the balancing effect achieved by the balancing spherical bodies 20d, while the balancing spherical bodies 20d in fact achieve the balancing effect more effectively.

It is also effective to prevent any influence on the balancing spherical bodies 20d by forming the yoke 139c in a cup shape, in which an opening section is formed at the top, to prevent the magnetic flux of the chucking magnet 139b from extending towards the holding magnet 20f, or by embedding an appropriate shield plate to extend horizontally within the disk table 139.

In the rotary drive device with the self-balancing mechanism 20 according to the present invention, due to the fact that the balancing spherical bodies 20 are made of a material with little residual magnetism, the magnetic effect of the holding magnet 20f on the balancing spherical bodies 20d acts consistently at all times regardless of the orientation or posture of the balancing spherical bodies 20d. Consequently, the repulsive force among the plurality of balancing spherical bodies 20d also acts consistently at all times, which effectively prevents noise caused by collisions among the balancing spherical bodies 20d and causes the balancing effect to be achieved even more effectively.

Each of the above effects has been described as applicable when the device is oriented horizontally as shown in FIG. 2. However, the same effects are basically applicable when the orientation is vertical so that the rotary shaft is horizontal, and significant actions and effects can be obtained in vertical orientation, especially with regard to noise prevention.

The embodiment of the present invention has been described in detail, but the present invention is not limited to the embodiment and many modifications can be made without departing from the present invention.

The present invention can be applied similarly to devices other than CD-ROM or DVD drive devices described in the embodiment, and a variety of motors such as servo motors and air motors are applicable.

As described above, in a rotary drive device according to the present invention, by configuring the number of effective revolutions, at which point a plurality of balancing spherical bodies moves outward in the radial direction away from a holding magnet, as a number of revolutions smaller than the number of resonant revolutions of a rotary body, the magnetic force that acts on each of the balancing spherical bodies is made small and the repulsive force among the balancing spherical bodies is weakened, which allow the plurality of balancing spherical bodies to concentrate in an area that would resolve an unbalance; consequently, the balancing spherical bodies can achieve sufficient balancing effect, while noise can be mitigated during low speed rotation of the rotary body by having the balancing spherical bodies repel each other due to the magnetic effect of the holding magnet, so that the rotary drive device can be maintained in a favorably balanced state and driven quietly.

Further in the rotary drive device according to the present invention, due to the fact that the magnetic force that acts on the balancing spherical bodies is set at a force that allows the balancing spherical bodies to move outward in the radial direction away from the holding magnet before the number of revolutions of the rotary body reaches the number of resonant revolutions, the number of effective revolutions can be obtained directly and securely; consequently, the effects described above can be effectively obtained.

Moreover, in the rotary drive device according to the present invention, by setting the number of effective revolutions at about 1900 rpm or less when the number of resonant revolutions of the rotary body is about 2000 rpm to about 3000 rpm, the effects described above can be effectively obtained. When the number of effective revolutions is set within the range of about 1000 rpm to about 1400 rpm, the effects described above can be securely obtained.

In the meantime, in the rotary drive device according to the present invention, a chucking magnet that fixes a disk member mounted on the rotary body consists of either a multipolar magnet with four or more magnetic poles in the circumferential direction, or a single-pole magnet with a single uniform magnetic pole in the circumferential direction, in order to make leakage flux from the chucking magnet to the holding magnet uniform and small in the circumferential direction. This reduces the impact of the leakage flux of the chucking magnet on the holding magnet, which enhances a noise reduction effect on each of the balancing spherical bodies and allows each of the balancing spherical bodies to achieve the balancing effect even more effectively, which in turn causes the effects described above to be further enhanced.

In the rotary drive device according to the present invention, due to the fact that the balancing spherical bodies are made of a material with little residual magnetism, the magnetic effect of the holding magnet on the balancing spherical bodies acts consistently at all times regardless of the orientation or posture of the balancing spherical bodies to effectively prevent noise caused by collisions among the balancing spherical bodies and to allow the balancing effect to be achieved even more effectively. Consequently, the effects described above can be further enhanced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A rotary drive device comprising:
a rotary body; and
a self-balancing device mounted on the rotary body, the self-balancing device including at least a plurality of balancing spherical bodies, and a holding magnet that magnetically attracts and holds the plurality of balancing spherical bodies during low speed rotations,
wherein the number of effective revolutions, at which point the plurality of balancing spherical bodies that is attracted to the holding magnet begins to move outward in the radial direction away from the holding magnet as the number of revolutions of the rotary body increases, is smaller than the number of resonant revolutions of the rotary body.

2. A rotary drive device according to claim 1, wherein the low speed rotations includes rotations of the rotary body at the time when the rotary body starts rotating.

3. A rotary drive device according to claim 1, wherein the force that acts on the balancing spherical bodies is set at a magnetic force that allows the balancing spherical bodies to move outward in the radial direction away from the holding magnet before the number of revolutions of the rotary body reaches the number of resonant revolutions.

4. A rotary drive device according to claim 1, wherein the number of effective revolutions is about 1900 rpm or less when the number of resonant revolutions of the rotary body is about 2000 rpm to about 3000 rpm.

5. A rotary drive device according to claim 1, wherein the number of effective revolutions is set between about 1000 rpm and about 1400 rpm when the number of resonant revolutions of the rotary body is about 2000 rpm to about 3000 rpm.

6. A rotary drive device comprising:
a rotary body driven by a motor unit; and
a self-balancing device mounted on the rotary body, the self-balancing device including a storing case driven by the motor unit, a holding magnet disposed in a central portion of the storing case, and a plurality of balancing spherical bodies stored in a freely moveable manner in the storing case, that are attracted by and held to the holding magnet during low speed rotations, including when the rotary body starts, and moved outward in a radial direction away from the holding magnet by a centrifugal force applied to the plurality of balancing spherical bodies as a result of the rotation of the rotary body, wherein each of the balancing spherical bodies is moved into a position that negates a rotational unbalance of the rotary body to achieve a balancing effect,
wherein the number of effective revolutions, at which point the plurality of balancing spherical bodies that is attracted to the holding magnet begins to move outward in the radial direction away from the holding magnet as the number of revolutions of the rotary body increases, is smaller than the number of resonant revolutions of the rotary body.

7. A rotary drive device according to claim 6, wherein the force that acts on the balancing spherical bodies is set at a magnetic force that allows the balancing spherical bodies to move outward in the radial direction away from the holding magnet before the number of revolutions of the rotary body reaches the number of resonant revolutions.

8. A rotary drive device according to claim 6, wherein the number of effective revolutions is about 1900 rpm or less when the number of resonant revolutions of the rotary body is about 2000 rpm to about 3000 rpm.

9. A rotary drive device according to claim 6, wherein the number of effective revolutions is set between about 1000 rpm and about 1400 rpm when the number of resonant revolutions of the rotary body is about 2000 rpm to about 3000 rpm.

10. A rotary drive device comprising
a rotary body:
a chucking magnet that fixes a disk member to the rotary body; and
a self-balancing device mounted on the rotary body, the self-balancing device including at least a plurality of balancing spherical bodies, and a holding magnet that magnetically attracts and holds the plurality of balancing spherical bodies during low speed rotations,
wherein the number of effective revolutions, at which point the plurality of balancing spherical bodies that is attracted to the holding magnet begins to move outward in the radial direction away from the holding magnet as the number of revolutions of the rotary body increases, is smaller than the number of resonant revolutions of the rotary body.

11. A rotary drive device comprising
a rotary body;
a chucking magnet that fixes a disk member to the rotary body; and
a self-balancing mechanism that generates a balancing effect to negate any rotational unbalance of the rotary body that occurs when the number of revolutions of the rotary body exceeds the number of resonant revolutions of the rotary body, wherein the chucking magnet is formed from a multipolar magnet with four or more magnetic poles arranged in the circumferential direction.

12. A rotary drive device according to claim 11, wherein the chucking magnet is disposed in proximity to the holding magnet and exerts a leakage magnetic flux on the holding magnet in an amount that is reduced by a magnetic pole arrangement of the mutipolar magnet.

13. A rotary drive device comprising:
a rotary body driven by a motor unit;
a chucking magnet for fixing a disk member to the rotary body, wherein the chucking magnet is formed from a multipolar magnet with four or more magnetic poles arranged in the circumferential direction; and
a self-balancing device mounted on the rotary body, the self-balancing device including a storing case driven by the motor unit, a holding magnet disposed in proximity to the chucking magnet and in a central portion of the storing case, and a plurality of balancing spherical bodies stored in a freely moveable manner in the storing case, that are attracted by and held to the holding magnet during low speed rotations, including when the rotary body starts, and moved outward in a radial direction away from the holding magnet by a centrifugal force applied to the plurality of balancing spherical bodies as a result of the rotation of the rotary body, wherein each of the balancing spherical bodies is moved into a position that negates a rotational unbalance of the rotary body to achieve a balancing effect,
wherein the number of effective revolutions, at which point the plurality of balancing spherical bodies that is attracted to the holding magnet begins to move outward in the radial direction away from the holding magnet as the number of revolutions of the rotary body increases, is smaller than the number of resonant revolutions of the rotary body.

14. A rotary drive device according to claim 13, wherein the chucking magnet exerts a leakage magnetic flux on the holding magnet in an amount that is reduced by a magnetic pole arrangement of the mutipolar magnet.

15. A rotary drive device comprising
a rotary body;
a chucking magnet for fixing a disk member to the rotary body; and
a self-balancing mechanism that generates a balancing effect to negate any rotational unbalance of the rotary body that occurs when the number of revolutions of the rotary body exceeds the number of resonant revolutions of the rotary body, wherein the chucking magnet is formed from a single-pole magnet with a uniform magnetic pole in the circumferential direction.

16. A rotary drive device according to claim 15, wherein the chucking magnet is disposed in proximity to the holding magnet and exerts a uniform leakage magnetic flux on the holding magnet.

17. A rotary drive device comprising:
a rotary body driven by a motor unit;
a chucking magnet for fixing a disk member to the rotary body, wherein the chucking magnet is formed from a single-pole magnet with a uniform magnetic pole in the circumferential direction; and
a self-balancing device mounted on the rotary body, the self-balancing device including a storing case driven by the motor unit, a holding magnet disposed in proximity to the chucking magnet and in a central portion of the storing case, and a plurality of balancing spherical bodies stored in a freely moveable manner in the storing case, that are attracted by and held to the holding magnet during low speed rotations, including when the rotary body starts, and moved outward in a radial direction away from the holding magnet by a centrifugal force applied to the plurality of balancing spherical bodies as a result of the rotation of the rotary body, wherein each of the balancing spherical bodies is moved into a position that negates a rotational unbalance of the rotary body to achieve a balancing effect,
wherein the number of effective revolutions, at which point the plurality of balancing spherical bodies that is attracted to the holding magnet begins to move outward in the radial direction away from the holding magnet as the number of revolutions of the rotary body increases, is smaller than the number of resonant revolutions of the rotary body.

18. A rotary drive device according to claim 17, wherein the chucking magnet exerts a uniform leakage magnetic flux on the holding magnet.

19. A rotary drive device comprising:
a rotary body driven by a motor unit; and
a self-balancing device mounted on the rotary body, the self-balancing device including a storing case driven by the motor unit, a holding magnet disposed in a central portion of the storing case, and a plurality of balancing spherical bodies stored in a freely moveable manner in the storing case, that are attracted by and held to the holding magnet during low speed rotations, including when the rotary body starts, and moved outward in a radial direction away from the holding magnet by a centrifugal force applied to the plurality of balancing spherical bodies as a result of the rotation of the rotary body, wherein each of the balancing spherical bodies is moved into a position that negates a rotational unbalance of the rotary body to achieve a balancing effect,
wherein the balancing spherical bodies are made of a material with a minimal residual magnetism compared to a residual magnetism of a magnetic material.

20. A rotary drive device according to claim 19, wherein the material with a minimal residual magnetism is chrome steel.

21. A rotary drive device according to claim 19, wherein the number of effective revolutions, at which point the plurality of balancing spherical bodies that is attracted to the holding magnet begins to move outward in the radial direction away from the holding magnet as the number of revolutions of the rotary body increases, is smaller than the number of resonant revolutions of the rotary body.
